(19) United States
(12) Patent Application Publication
(10) Pub. No.: US 2026/0337331 A1
(43) Pub. Date: Oct. 29, 2026

(54) EPOXY RESIN COMPOSITION FOR SPACE ENVIRONMENT AND METHOD FOR PRODUCING MODIFIED EPOXY RESIN USING THE SAME

(71) Applicant: AGENCY FOR DEFENSE DEVELOPMENT, Daejeon (KR)

(72) Inventors: Jongsung WON, Daejeon (KR); Man Young LEE, Daejeon (KR); Eun Hye LEE, Daejeon (KR); Yongyoon CHO, Daejeon (KR); Jieun LEE, Daejeon (KR); Mina KIM, Daejeon (KR)

(21) Appl. No.: 19/630,394

(22) Filed: Mar. 26, 2026

(30) Foreign Application Priority Data
Apr. 16, 2025 (KR) 10-2025-0049312

(51) Int. Cl. C08G 59/32; C08G 59/50; C08K 5/134; C08K 5/3435; C08K 5/37; C08K 5/526

(52) U.S. Cl. CPC C08G 59/3227; C08G 59/5006; C08G 59/504; C08K 5/1345; C08K 5/3435; C08K 5/37; C08K 5/526

(57) ABSTRACT

The present disclosure provides an epoxy resin composition for a space environment and a method for producing a modified epoxy resin using the same.

### CROSS-REFERENCE TO RELATED APPLICATION

This application claims priority to Korean Patent Application No. 10-2025-0049312 filed on Apr. 16, 2025, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to an epoxy resin composition for a space environment and a method for producing a modified epoxy resin using the same.

### 2. Description of the Related Art

Carbon composite materials exhibit excellent dimensional stability due to their low coefficient of thermal deformation, and have advantages in that lightweight structures can be fabricated because of their high specific strength and specific stiffness, and thus are widely used as core structural materials for space structures. However, despite such excellent properties, several problems arise in the application of conventional carbon composite materials in a Low Earth Orbit (LEO) environment.

In particular, when an epoxy resin used in the manufacture of carbon composite materials is exposed to a space environment for a long period of time, chemical degradation occurs, and as a result, mechanical properties such as stiffness, strength, and glass transition temperature are changed together with physical properties such as density and dimensions, and thus the service life is reduced and use in a space environment is limited. Changes in the chemical structure and physical properties of the epoxy resin in a space environment are important factors that must be considered for designing highly reliable space structures, and quantitative evaluation thereof is essential.

Major factors that deteriorate the physical properties of carbon composite materials in a space environment include extreme temperature variations and strong ultraviolet rays. Such environmental factors deteriorate the physical and mechanical properties of the structure, resulting in shortening of the expected fatigue life. In particular, rapid changes in external temperature cause a difference in coefficients of thermal expansion between fibers and resin inside the composite material, thereby causing deformation of the resin, and may generate defects such as interfacial failure at the fiber/resin interface and cracks.

Accordingly, in order to solve these problems, it is essential to develop an epoxy resin composition for a space environment capable of withstanding a space thermal cycling environment simulation test. Conventional epoxy resins have mainly been modified to improve heat resistance; however, recently, in order to secure properties suitable for a space environment, prevention of deterioration due to solar radiation and excellent thermal shielding performance are also required.

Therefore, the inventors of the present disclosure have developed a modified epoxy resin in which radiation resistance and heat resistance are improved so that the chemical structure and mechanical properties are maintained even in a space environment, in order to overcome the conventional limitations described above.

### RELATED PATENT DOCUMENT

(Patent Document 1) Korean Registered Patent Publication No. 10-2712206 (Publication Date: Oct. 4, 2024)

### SUMMARY OF THE DISCLOSURE

The purpose of the present disclosure is to provide a modified epoxy resin composition having excellent stability even in a space environment and a method for producing the modified epoxy resin. To this end, specifically, the present disclosure provides a modified epoxy resin composition having improved radiation resistance and heat resistance and a method for producing a modified epoxy resin.

The problems to be solved by the present disclosure are not limited to those mentioned above, and other issues not explicitly stated will be clearly understood by those skilled in the art from the following description.

In order to achieve the purpose, one aspect of the present disclosure provides a modified epoxy resin composition comprising:
an epoxy resin (A);
a compound (B) represented by Chemical Formula 1 below;
a compound (C) represented by Chemical Formula 2 below;
a compound (D) represented by Chemical Formula 3 below; and
a compound (E) represented by Chemical Formula 4 below:

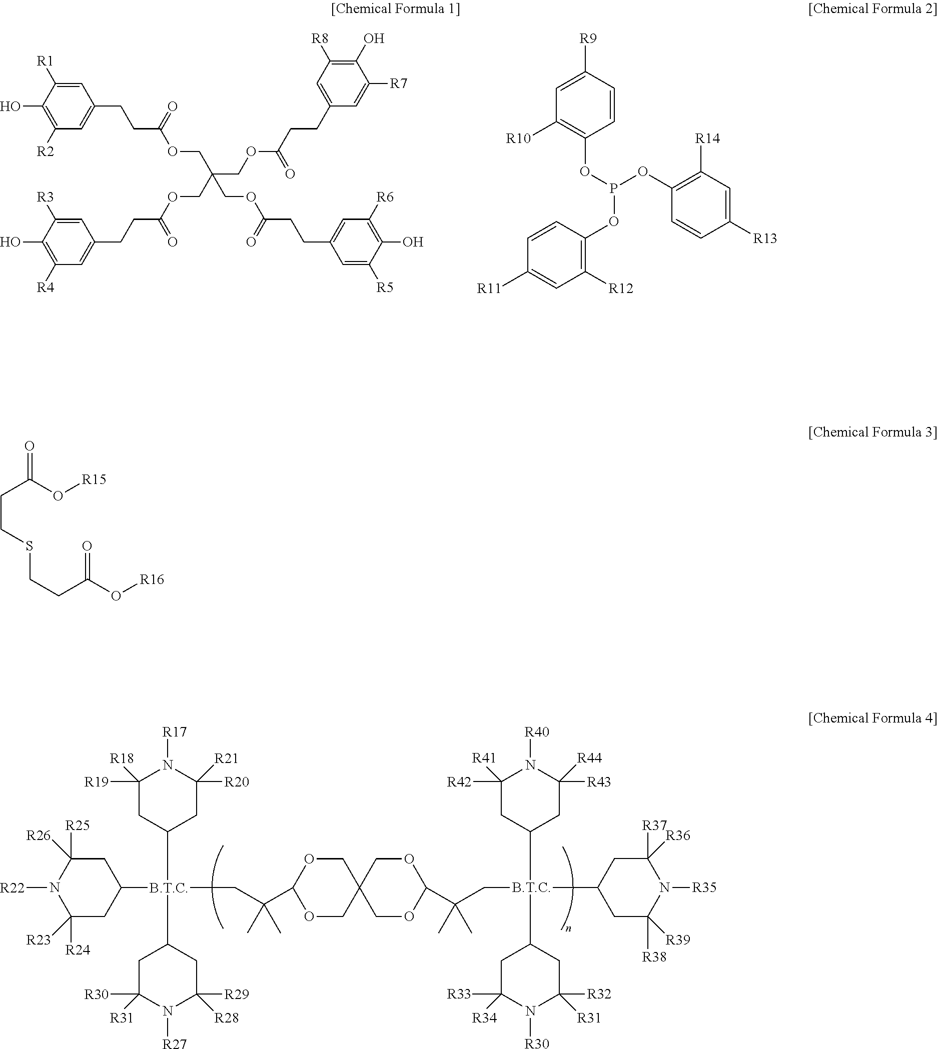

wherein, in the above formulas,
R1 to R44 are each independently hydrogen, or a substituted or unsubstituted linear or branched C1-C30 alkyl group,
wherein the substituent is one or a combination of two or more selected from the group consisting of hydroxy, amino, alkyl, alkoxy, alkylamino, dialkylamino, aryl, aryloxy, arylamino, diarylamino, heteroaryl, epoxy, aldehyde, ketone, and carboxylic acid ester,
wherein B.T.C. (butanetetracarboxylate) is

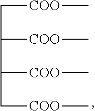

and
wherein n is an integer ranging from 1 to 20.

In some exemplary embodiments, the epoxy resin may be any one or a combination of two or more selected from the group consisting of bisphenol A epoxy resin, bisphenol F epoxy resin, bisphenol S epoxy resin, bisphenol M epoxy resin, and bisphenol AD epoxy resin, trimethylolpropane triglycidyl ether epoxy resin, triglycidyl isocyanurate, trimethylolmethane triglycidyl ether, tetraglycidyl methylenedianiline epoxy resin, tetraglycidyl diaminodiphenylmethane epoxy resin, novolac-based tetraglycidyl epoxy resin, tetraglycidyl cresol novolac epoxy resin, and phenol novolac epoxy resin.

In some exemplary embodiments, based on 100 parts by weight of the epoxy resin (A), 0.01 to 10.0 parts by weight of the compound (B), 0.01 to 10.0 parts by weight of the compound (C), 0.01 to 10.0 parts by weight of the compound (D), and 0.01 to 10.0 parts by weight of the compound (E) may be included.

In some exemplary embodiments, the composition may further comprise a curing agent.

In some exemplary embodiments, 20 to 50 parts by weight of the curing agent may be included based on 100 parts by weight of the epoxy resin (A).

In some exemplary embodiments, the curing agent may be any one or a combination of two or more selected from the group consisting of diethylenetriamine, triethylene diamine, triethylenetetramine, tetraethylene-pentamine, 2,2,4- and/or 2,4,4-trimethylhexamethylenediamine, 1,6-hexanediamine, 1-ethyl-1,3-propanediamine, 2,2 (4),4-trimethyl-1,6-hexanediamine, bis(3-aminopropyl) piperazine, N-aminoethylpiperazine, N,N-bis(3-aminopropyl)ethylenediamine, 1,2-diaminocyclohexane, 1,4-diamino-2,5-diethylcyclohexane, 1,2-diamino-4-ethylcyclohexane, 1,4-diamino-2,5-diethylcyclo-hexane, 1,2-diamino-4-cyclohexylcyclohexane, isophorone diamine, norbornanediamine, 4,4′-diaminodicyclohexylmethane, 4,4′-diaminodicyclohexylethane, 4,4′-diaminodicyclohexylpropane, 2,2-bis(4-aminocyclohexyl) propane, 3,3′-dimethyl-4,4′-diaminodicyclohexylmethane, 3-amino-1-(4-aminocyclohexyl) propane, 1,3- and 1,4-bis(aminomethyl)cyclohexane, 3,3′-diaminodiphenylsulfone, 4,4′-diaminodiphenylsulfone, meta-methylisopropylamine, and meta-diethylamine.

Another aspect of the present disclosure provides a modified epoxy resin using the modified epoxy resin composition according to the one aspect of the present disclosure.

Still another aspect of the present disclosure provides a modified epoxy resin comprising the modified epoxy resin composition according to the one aspect of the present disclosure.

The modified epoxy resin of the present disclosure has the effect of exhibiting excellent thermal stability and radiation resistance. In particular, even when exposed to an extreme environment aging test, which is a space environment simulation test, mechanical properties are maintained, and color retention (meaning that the polymer is not decomposed) confirms that there are no surface defects and decomposition, and through these results, it can be understood that the shielding effect against solar radiation occurring in space is excellent.

Accordingly, the modified epoxy resin of the present disclosure may be used as a main material for satellites and aircraft used in the aerospace field.

The effects of the present disclosure are not limited to the aforementioned effects and should be understood to include all effects that can be inferred from the configurations of the present disclosure described in the detailed description or the claims.

### BRIEF DESCRIPTION OF THE DRAWINGS

FIG. 1 is a schematic diagram illustrating extreme environment aging test conditions according to an exemplary embodiment of the present disclosure.

FIG. 2 illustrates real-image microscope analysis results after the aging test according to the extreme environment aging test according to an exemplary embodiment of the present disclosure.

FIG. 3 illustrates contact angle analysis results after the aging test according to the extreme environment aging test according to an exemplary embodiment of the present disclosure.

### DETAILED DESCRIPTION OF THE DISCLOSURE

Hereinafter, exemplary embodiments of the present disclosure will be described in detail with reference to related drawings.

Advantages and features of the present disclosure and methods to implement them will now be described more fully hereinafter with reference to exemplary embodiments accompanied by drawings.

The present disclosure may, however, be embodied in different forms and should not be construed as limited to the exemplary embodiments set forth herein. Rather, these exemplary embodiments are provided so that this disclosure will be thorough and complete, and will fully convey the scope of the present disclosure to those skilled in the art. The scope of the present disclosure shall be defined only by the scope of claims.

When it is determined that a detailed description about known function or structure relating to the present disclosure may evade the main point of the present disclosure, the detailed description may be omitted.

Hereinafter, a detailed description of the present disclosure is provided.

Epoxy resins currently developed and in use maintain excellent structural stability and mechanical properties at room temperature; however, when exposed to a space environment for a long period of time, chemical decomposition occurs due to complex factors such as strong ultraviolet (UV) rays emitted from the sun, high-energy radiation (γ-rays, X-rays, electron beams, etc.), and extreme temperature changes (thermal cycling), thereby resulting in deterioration of physical properties. Such deterioration of physical properties leads to a reduction in service life, making long-term use difficult when applied to satellites and causing performance degradation. Therefore, in order to secure long-term stability in a space environment, it is essential to develop a modified epoxy resin having excellent radiation resistance and thermal stability.

The present disclosure is intended to solve the above problems, and provides a modified epoxy resin for a space environment and a method for producing the same, which can maintain high stability even in an extreme space environment by including phenolic, phosphorus-based, sulfur-based, and amine-based additives that improve radiation resistance and heat resistance in an epoxy resin.

The present disclosure provides a modified epoxy resin composition comprising: an epoxy resin (A); a compound (B) represented by Chemical Formula 1 below; a compound (C) represented by Chemical Formula 2 below; a compound (D) represented by Chemical Formula 3 below; and a compound (E) represented by Chemical Formula 4 below:

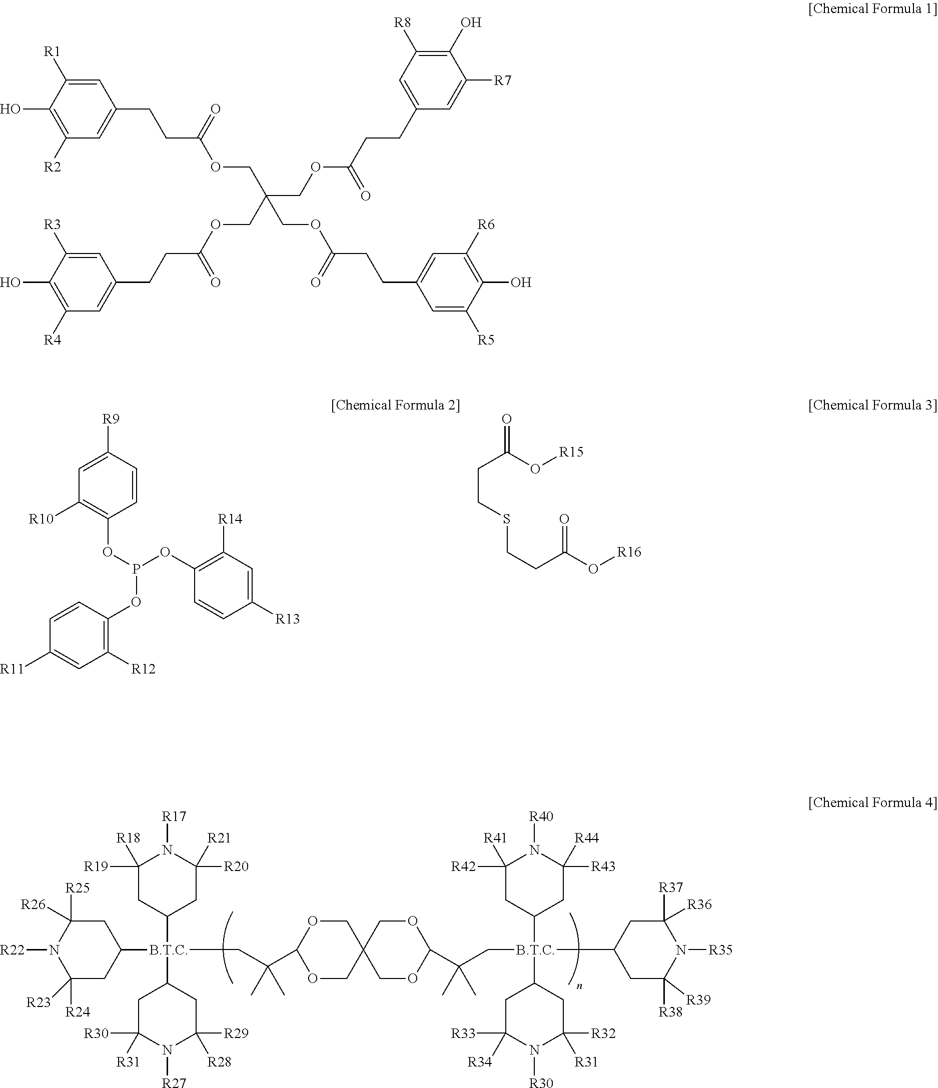

In the above formulas, R1 to R44 are each independently hydrogen, or a substituted or unsubstituted linear or branched C1-C30 alkyl group,
wherein the substituent is one or a combination of two or more selected from the group consisting of hydroxy, amino, alkyl, alkoxy, alkylamino, dialkylamino, aryl, aryloxy, arylamino, diarylamino, heteroaryl, epoxy, aldehyde, ketone, and carboxylic acid ester,
wherein B.T.C. (butanetetracarboxylate) is

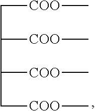

and
wherein n is an integer ranging from 1 to 20.

The epoxy resin is a thermosetting resin including an epoxide functional group, and the epoxy resin has advantages such as high adhesive strength, mechanical strength, excellent chemical resistance, electrical insulation properties, water resistance, and moisture resistance. However, when exposed to a space environment for a long period of time, chemical decomposition occurs, and as a result, mechanical properties such as stiffness, strength, and glass transition temperature are changed together with physical properties such as density and dimensions, and thus the service life is reduced and use in a space environment is limited.

Accordingly, the present disclosure solves the problems of conventional epoxy resins as described above by providing a composition in which phenolic, phosphorus-based, sulfur-based, and amine-based compounds are added to an epoxy resin and a modified epoxy resin manufactured using the same.

The epoxy resin (A) may include any one or a combination of two or more selected from monofunctional groups, difunctional groups, trifunctional groups, tetrafunctional groups, and trifunctional groups or higher.

The monofunctional group may be any one or a combination of two or more selected from glycidyl ether, alkyl glycidyl ether, glycidyl ester, and allyl glycidyl ether.

The difunctional group may be any one or a combination of two or more selected from bisphenol-A epoxy resin, bisphenol-F epoxy resin, bisphenol-S epoxy resin, bisphenol-M epoxy resin, and bisphenol-AD epoxy resin.

The trifunctional group may be any one or a combination of two or more selected from trimethylolpropane triglycidyl epoxy resin, trimethylolmethane triglycidyl ether, and triglycidyl isocyanurate.

The tetrafunctional group may be any one or a combination of two selected from tetraglycidyl methylenedianiline and tetraglycidyl diaminodiphenylmethane.

The trifunctional group or higher may be any one or a combination of two or more selected from novolac-based tetraglycidyl epoxy resin, tetraglycidyl cresol novolac epoxy resin, and phenol novolac epoxy resin.

In addition, the epoxy resin (A) may be any one or a combination of two or more selected from the group consisting of bisphenol A epoxy resin, bisphenol F epoxy resin, bisphenol S epoxy resin, bisphenol M epoxy resin, and bisphenol AD epoxy resin, trimethylolpropane triglycidyl ether epoxy resin, triglycidyl isocyanurate, trimethylolmethane triglycidyl ether, tetraglycidyl methylenedianiline epoxy resin, tetraglycidyl diaminodiphenylmethane epoxy resin, novolac-based tetraglycidyl epoxy resin, tetraglycidyl cresol novolac epoxy resin, and phenol novolac epoxy resin.

In the modified epoxy resin composition, based on 100 parts by weight of the epoxy resin (A), 0.01 to 10.0 parts by weight of the compound (B), 0.01 to 10.0 parts by weight of the compound (C), 0.01 to 10.0 parts by weight of the compound (D), and 0.01 to 10.0 parts by weight of the compound (E) may be included.

The compound (B) may be a phenolic compound represented by Chemical Formula 1 above, and may be included in an amount of 0.01 to 10.0 parts by weight based on 100 parts by weight of the epoxy resin (A). When the amount is less than the minimum value, there is a problem in that the compound is easily decomposed at the temperature of a space environment, thereby reducing structural stability. When the amount exceeds the maximum value, there is a problem in that mechanical properties are reduced due to dispersion problems during manufacture, making use in a space environment difficult.

The compound (C) may be a phosphorus-based compound represented by Chemical Formula 2 above, and may be included in an amount of 0.01 to 10.0 parts by weight based on 100 parts by weight of the epoxy resin (A). When the amount is less than the minimum value, there is a problem in that, upon exposure to heat at the temperature of a space environment, free radicals cannot be removed, thereby allowing epoxy decomposition to proceed, resulting in deterioration of physical properties and discoloration. When the amount exceeds the maximum value, there is a problem in that the appearance is contaminated during manufacture and the compound added during the manufacturing process interferes with epoxy curing, thereby lowering thermal stability and making use in a space environment difficult.

The compound (D) may be a sulfur-based compound represented by Chemical Formula 3 above, and may be included in an amount of 0.01 to 10.0 parts by weight based on 100 parts by weight of the epoxy resin (A). When the amount is less than the minimum value, there is a problem in that, when left for a long period of time in a space environment, epoxy decomposition is accelerated by heat, thereby reducing physical properties. When the amount exceeds the maximum value, there is a problem in that heat resistance decreases due to contamination of appearance color and non-uniform curing of epoxy caused by excessive addition.

The compound (E) may be an amine-based compound represented by Chemical Formula 4 above, and may be included in an amount of 0.01 to 10.0 parts by weight based on 100 parts by weight of the epoxy resin (A). When the amount is less than the minimum value, there is a problem in that, upon exposure to a space environment, the molecular structure is destroyed by ultraviolet rays and radiation, aging is accelerated, and physical properties are rapidly deteriorated. When the amount exceeds the maximum value, there is a problem in that mechanical properties are reduced due to an influence on the epoxy structure.

The modified epoxy resin composition according to the present disclosure may further comprise a curing agent.

The curing agent may be included in an amount of 20 to 50 parts by weight based on 100 parts by weight of the epoxy resin (A).

When the amount is less than the minimum value, there is a problem in that use in a space environment is difficult due to deterioration of mechanical properties and heat resistance. When the amount exceeds the maximum value, there is a problem in that an unbalanced network structure is formed, mechanical properties are reduced, and the reaction rate becomes too fast, thereby causing cracks or deformation due to problems such as shrinkage.

The curing agent may be any one or a combination of two or more selected from the group consisting of diethylenetriamine, triethylene diamine, triethylenetetramine, tetraethylene-pentamine, 2,2,4- and/or 2,4,4-trimethylhexamethylenediamine, 1,6-hexanediamine, 1-ethyl-1,3-propanediamine, 2,2 (4),4-trimethyl-1,6-hexanediamine, bis(3-aminopropyl) piperazine, N-aminoethylpiperazine, N,N-bis(3-aminopropyl)ethylenediamine, 1,2-diaminocyclohexane, 1,4-diamino-2,5-diethylcyclohexane, 1,2-diamino-4-ethylcyclohexane, 1,4-diamino-2,5-diethylcyclo-hexane, 1,2-diamino-4-cyclohexylcyclohexane, isophorone diamine, norbornanediamine, 4,4′-diaminodicyclohexylmethane, 4,4′-diaminodicyclohexylethane, 4,4′-diaminodicyclohexylpropane, 2,2-bis(4-aminocyclohexyl) propane, 3,3′-dimethyl-4,4′-diaminodicyclohexylmethane, 3-amino-1-(4-aminocyclohexyl) propane, 1,3- and 1,4-bis(aminomethyl)cyclohexane, 3,3′-diaminodiphenylsulfone, 4,4′-diaminodiphenylsulfone, meta-methylisopropylamine, and meta-diethylamine.

The curing agent may preferably be a mixture of 3,3′-diaminodiphenylsulfone, 4,4′-diaminodiphenylsulfone, meta-methylisopropylamine, and meta-diethylamine, and the four curing agents may be mixed at a weight ratio of 1:1:5:10 to 10:10:30:50 based on 100 parts by weight of the epoxy resin, and more preferably, the four curing agents may be mixed in equal amounts, respectively. This is for mechanical properties and heat resistance characteristics that can be used in a space environment.

In addition, the present disclosure provides a modified epoxy resin using the modified epoxy resin composition as described above.

In a method for producing the modified epoxy resin according to the present disclosure, the modified epoxy resin may be produced using the above-described modified epoxy resin composition as a raw material.

Specific details regarding the modified epoxy resin composition are omitted herein since they overlap with those described above.

In particular, the method for producing the modified epoxy resin of the present disclosure may be performed by including a step of mixing and curing the above-described modified epoxy resin composition.

In addition, the method for producing the modified epoxy resin of the present disclosure may be performed by including a step of mixing the above-described modified epoxy resin composition (A, B, C, D, and E) and a step of adding a curing agent and curing the same.

Preferably, the method for producing the modified epoxy resin of the present disclosure may be performed by including (primarily) a step of mixing the above-described modified epoxy resin composition (A, B, C, D, and E) and a curing agent, and (secondarily) further adding and mixing the above-described additives (any one or two or more selected from B, C, D, and E) and a curing agent to the mixture.

However, the method for producing the modified epoxy resin according to the present disclosure is not limited thereto as long as the above-described modified epoxy resin composition is used, and may be performed by a method commonly used in the technical field of the present disclosure.

In addition, the present disclosure provides a modified epoxy resin comprising the above-described modified epoxy resin composition.

The modified epoxy resin of the present disclosure may comprise the above-described modified epoxy resin composition as a raw material.

Further, the modified epoxy resin of the present disclosure may be prepared by the above-described modified epoxy resin composition and the above-described method for producing the modified epoxy resin.

Specific details regarding the modified epoxy resin composition are omitted herein since they overlap with those described above.

However, the modified epoxy resin according to the present disclosure is not limited thereto as long as it comprises the above-described modified epoxy resin composition, and may follow manufacturing methods, forms, or uses commonly employed in the technical field of the present disclosure.

### EXEMPLARY EMBODIMENTS

Hereinafter, exemplary embodiments are presented to aid in the understanding of the present disclosure; however, the following embodiments are merely illustrative and are not intended to limit the scope of the present disclosure.

### Materials

The following components were used in the following Examples and Comparative Examples.
Epoxy resin (A): tetraglycidyl methylenedianiline epoxy resin
Compound (B): Pentaerythritol tetrakis[3-[3,5-di-tert-butyl-4-hydroxyphenyl]propionate

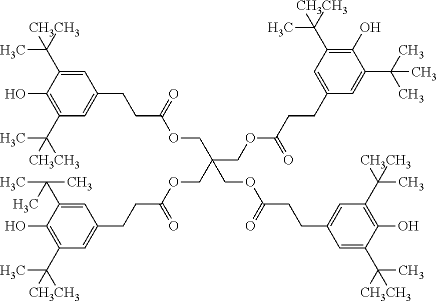 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

Compound (C): Tris(2,4-ditert-butylphenyl)phosphate

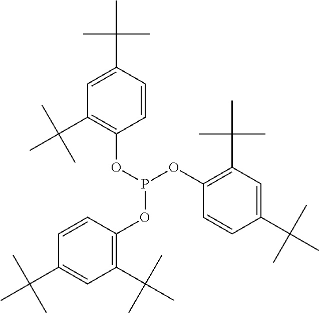 [SMILES: CC(C)(C)c1ccc(OP(Oc2ccc(C(C)(C)C)cc2C(C)(C)C)Oc2ccc(C(C)(C)C)cc2C(C)(C)C)c(C(C)(C)C)c1]

Compound (D): Distearylthiodipropionate (DSTDP)Dioctadecyl 3,3′-thiodipropanoate

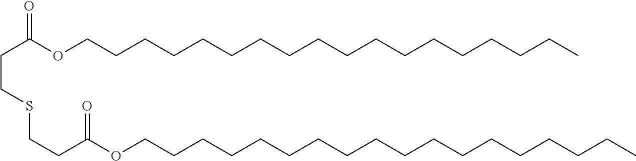 [SMILES: CCCCCCCCCCCCCCCCCCOC(=O)CCSCCC(=O)OCCCCCCCCCCCCCCCCCC]

Compound (E): 1,2,3,4-Butanetetracarboxylic acid, tetramethyl ester, reaction products with 1,2,2,6,6-pentamethyl-4-piperidinol and β,β,β′,β′-tetramethyl-2,4,8,10-tetraoxaspiro[5.5]undecane-3,9-diethanol

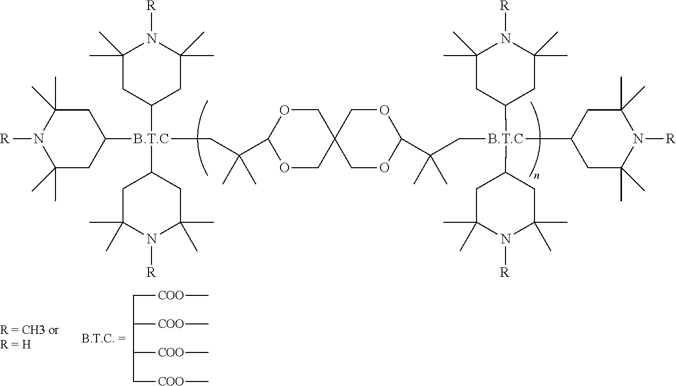

Curing agent: a mixture including four curing agents, namely 3,3′-diaminodiphenylsulfone, 4,4′-diaminodiphenylsulfone, meta-methylisopropylamine, and meta-diethylamine, at a ratio of 1:1:1:1

### Preparation Example

The composite materials of the following Examples and Comparative Examples were prepared by the following method.

First, one of the epoxy resin compositions (1) (A+B+C+D+E) and one of the curing agents (3) were primarily placed in a stirrer and stirred at a reaction temperature of 85 to 105° C. for 30 to 90 minutes.

In addition, secondarily, one of the curing agents (3) and additive compounds, namely (B) Pentaerythritol tetrakis[3-[3,5-di-tert-butyl-4-hydroxyphenyl]propionate], (C) Tris(2,4-di-tert-butylphenyl)phosphite, (D) Distearylthiodipropionate (DSTDP), dioctadecyl 3,3′-thiodipropanoate, and (E) 1,2,3,4-Butanetetracarboxylic acid, tetramethyl ester, reaction products with 1,2,2,6,6-pentamethyl-4-piperidinol and β,β,β′,β′-tetramethyl-2,4,8,10-tetraoxaspiro[5.5]undecane-3,9-diethanol were added and stirred at a reaction temperature of 70 to 90° C. for 30 to 90 minutes to prepare the composite materials.

### Example 1

Based on 100 parts by weight of tetraglycidyl methylenedianiline epoxy resin, 0.05 parts by weight of compound (B), 0.1 parts by weight of compound (C), 0.4 parts by weight of compound (D), and 0.1 parts by weight of compound (E), and 30 parts by weight of a mixture of 3,3′-diaminodiphenylsulfone, 4,4′-diaminodiphenylsulfone, meta-methylisopropylamine, and meta-diethylamine (1:1:1:1) as a curing agent were mixed to obtain a composite material that can be used in a space environment.

### Comparative Example 1

The same procedure as in Example 1 was performed except that compounds (C), (D), and (E) were not added.

### Comparative Example 2

The same procedure as in Example 1 was performed except that compounds (B), (D), and (E) were not added.

### Comparative Example 3

The same procedure as in Example 1 was performed except that compounds (B), (C), and (E) were not added.

### Comparative Example 4

The same procedure as in Example 1 was performed except that compounds (B), (C), and (D) were not added.

### Comparative Example 5

The same procedure as in Example 1 was performed except that compounds (C) and (D) were not added.

### Experimental Example 1

The glass transition temperature of the composite materials obtained in Example 1 and Comparative Examples 1 to 5 was analyzed, and the results are shown in Table 1. The glass transition temperature was measured according to ASTM D7028.

### Experimental Example 2

In the thermal environment of space and in satellite thermal design testing, there is a thermal cycling test. The thermal cycling test is a test method in which a specimen is periodically exposed to high-temperature and low-temperature conditions.

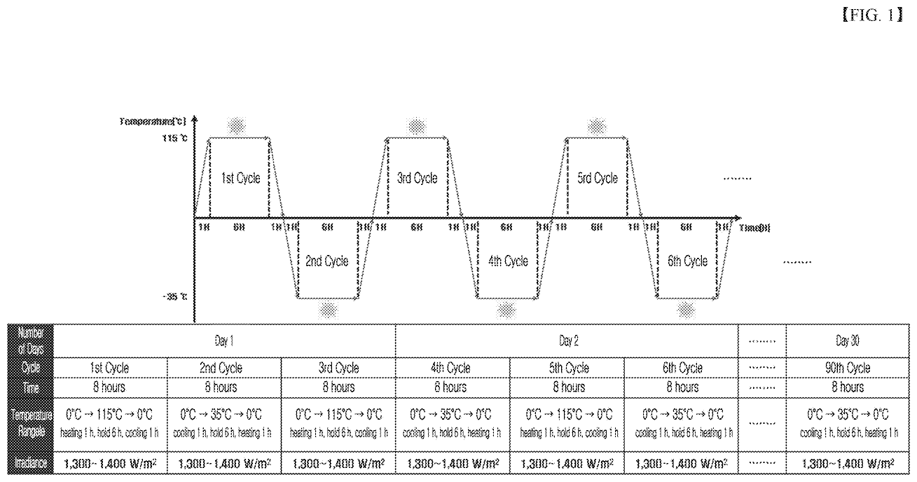

The specimens prepared in Example 1 and Comparative Examples 1 to 5 were exposed to an irradiance of 1,300 to 1,400 W/m² as shown in FIG. 1, and were periodically exposed to high-temperature and low-temperature conditions for 90 cycles to conduct an extreme environment aging test.

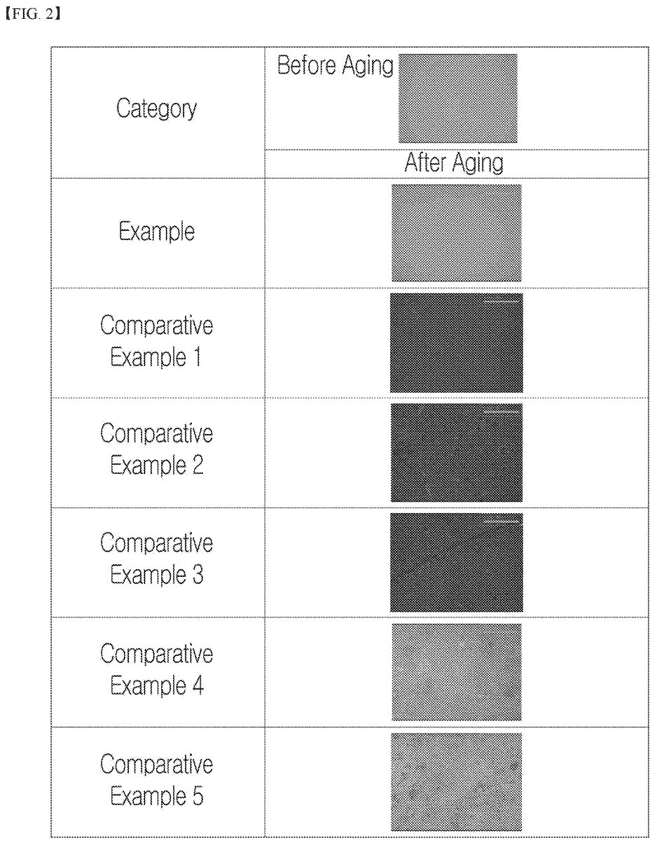

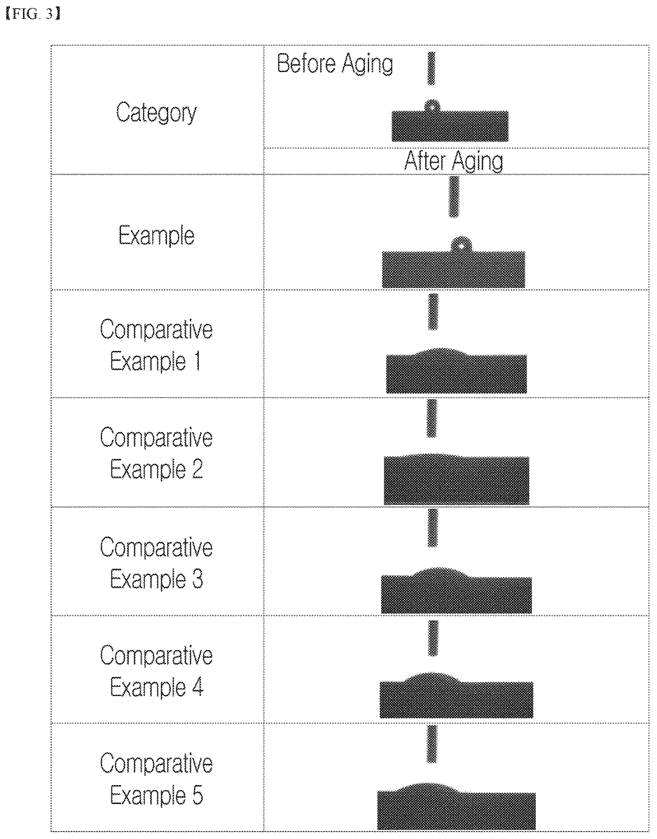

The color difference analysis and mechanical property values (tensile properties and flexural properties) before and after aging according to the extreme environment aging test are shown in Table 2 (before aging) and Table 3 (after aging), and the results of the real-image optical microscopy analysis and the contact angle analysis are shown in FIG. 2 and FIG. 3, respectively. The tensile properties were measured according to ASTM D3039, and the flexural properties were measured according to ASTM D790.

TABLE 1

| | Epoxy | | | | | Curing | Glass | |
|---|---|---|---|---|---|---|---|---|
| | Resin | Compound | Compound | Compound | Compound | Agent | Transition | |
| Category | (A) | (B) | (C) | (D) | (E) | (3) | Temperature | |
| Example | 100 | 0.05 | 0.1 | 0.4 | 0.1 | 30 | 202.6 | °C |
| Comparative | 100 | 0.05 | — | — | — | 30 | 203 | °C |
| Example 1 | | | | | | | | |
| Comparative | 100 | — | 0.1 | — | — | 30 | 202.5 | °C |
| Example 2 | | | | | | | | |
| Comparative | 100 | — | — | 0.4 | — | 30 | 202.5 | °C |
| Example 3 | | | | | | | | |
| Comparative | 100 | — | — | — | 0.1 | 30 | 202 | °C |
| Example 4 | | | | | | | | |
| Comparative | 100 | 0.05 | — | — | 0.1 | 30 | 203 | °C |
| Example 5 | | | | | | | | |

Referring to Table 1, it was confirmed that all of the composite materials obtained in Example and Comparative Examples 1 to 5 exhibited a glass transition temperature of 200° C. or higher, which is a temperature usable in a space environment.

TABLE 2

| | | | | | | Color |
|---|---|---|---|---|---|---|
| | Tensile Properties | | | Flexural Properties | | Dif- |
| | Tensile | Tensile | Elonga- | Flexural | Flexural | fer- |
| | Strength | Modulus | tion | Modulus | Strength | ence |
| Category | (MPa) | (GPa) | (%) | (GPa) | (MPa) | (ΔE) |
| Example | 109.17 | 3.33 | 7.05 | 3.43 | 168.95 | 13.24 |
| Comparative | 110.25 | 3.32 | 6.95 | 3.44 | 165.85 | 12.15 |
| Example 1 | | | | | | |
| Comparative | 105.99 | 3.31 | 7.01 | 3.42 | 163.71 | 11.88 |
| Example 2 | | | | | | |
| Comparative | 107.56 | 3.34 | 7.15 | 3.45 | 169.15 | 14.56 |
| Example 3 | | | | | | |
| Comparative | 108.25 | 3.35 | 6.98 | 3.50 | 170.35 | 15.23 |
| Example 4 | | | | | | |
| Comparative | 111.56 | 3.33 | 7.07 | 3.43 | 167.59 | 13.45 |
| Example 5 | | | | | | |

TABLE 3

| | | | | | | Color |
|---|---|---|---|---|---|---|
| | Tensile Properties | | | Flexural Properties | | Dif- |
| | Tensile | Tensile | Elonga- | Flexural | Flexural | fer- |
| | Strength | Modulus | tion | Modulus | Strength | ence |
| Category | (MPa) | (GPa) | (%) | (GPa) | (MPa)) | (ΔE) |
| Example | 105.99 | 3.30 | 6.89 | 3.39 | 161.77 | 15.14 |
| Comparative | 91.52 | 2.98 | 5.95 | 3.14 | 145.85 | 74.40 |
| Example 1 | | | | | | |
| Comparative | 87.75 | 2.95 | 5.52 | 3.01 | 139.78 | 74.26 |
| Example 2 | | | | | | |
| Comparative | 79.96 | 2.81 | 5.13 | 2.89 | 135.77 | 73.36 |
| Example 3 | | | | | | |
| Comparative | 93.16 | 2.99 | 6.01 | 3.19 | 146.97 | 66.02 |
| Example 4 | | | | | | |
| Comparative | 94.94 | 3.01 | 6.10 | 3.20 | 147.71 | 69.78 |
| Example 5 | | | | | | |

Comparing the results before aging in Table 2 and after aging in Table 3, the composite material according to the present disclosure (Example 1) did not show a significant difference in color difference and mechanical properties (tensile properties and flexural properties); however, the composite materials according to Comparative Examples 1 to 5 exhibited severe color change after aging compared to before aging, and a significant decrease in mechanical properties (tensile properties and flexural properties) was observed.

Referring to FIG. 2, the composite material according to the present disclosure (Example 1) showed almost the same color before and after aging; however, the composite materials according to Comparative Examples 1 to 5 exhibited a significant color change after aging compared to before aging.

In addition, referring to FIG. 3, the composite material according to the present disclosure (Example 1) showed almost the same contact angle before and after aging; however, the composite materials according to Comparative Examples 1 to 5 showed a significant decrease in contact angle after aging compared to before aging.

In the above, specific exemplary embodiments of an epoxy resin composition for a space environment and a method for producing a modified epoxy resin using the same according to the present disclosure have been described. However, it will be apparent that various modifications can be made without departing from the scope of the present disclosure.

Therefore, the scope of the present disclosure should not be limited to the described exemplary embodiments, but should be defined by the following claims and their equivalents.

That is, the foregoing embodiments are illustrative in all aspects and not limiting, and the scope of the present disclosure should be indicated by the claims described below rather than the detailed description. All modifications and variations derived from the meaning, scope, and equivalent concepts of the claims should be construed as being included within the scope of the present disclosure.

1. A modified epoxy resin composition comprising:
an epoxy resin (A);
a compound (B) represented by Chemical Formula 1 below;
a compound (C) represented by Chemical Formula 2 below;
a compound (D) represented by Chemical Formula 3 below; and
a compound (E) represented by Chemical Formula 4 below,
wherein, based on 100 parts by weight of the epoxy resin (A),
0.01 to 10.0 parts by weight of the compound (B),
0.01 to 10.0 parts by weight of the compound (C),
0.01 to 10.0 parts by weight of the compound (D), and
0.01 to 10.0 parts by weight of the compound (E)
are included,
wherein the modified epoxy resin composition is for a space environment and has improved radiation resistance and heat resistance:
[Chemical Formula 1] 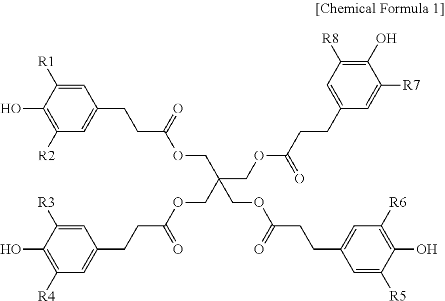
wherein Chemical Formula 1 is Pentaerythritol tetrakis[3-[3,5-di-tert-butyl-4-hydroxyphenyl]propionate].
[Chemical Formula 2] 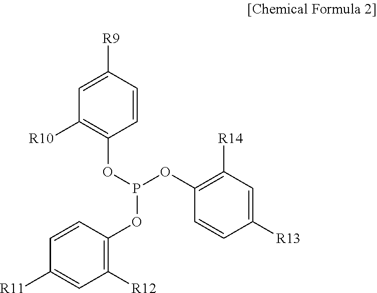
[Chemical Formula 3] 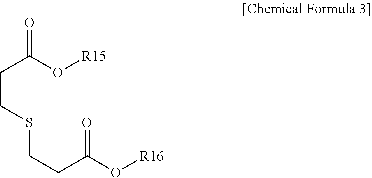
[Chemical Formula 4] 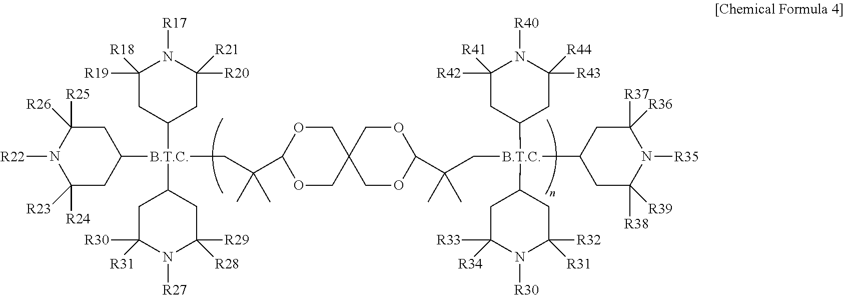
wherein, in the above formulas,
R9 to R44 are each independently hydrogen, or a substituted or unsubstituted linear or branched C1-C30 alkyl group,
wherein the substituent is one or a combination of two or more selected from the group consisting of hydroxy, amino, alkyl, alkoxy, alkylamino, dialkylamino, aryl, aryloxy, arylamino, diarylamino, heteroaryl, epoxy, aldehyde, ketone, and carboxylic acid ester,
wherein B.T.C. (butanetetracarboxylate) is 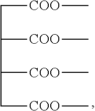
and
wherein n is an integer ranging from 1 to 20.

2. The modified epoxy resin composition of claim 1,
wherein the epoxy resin is any one or a combination of two or more selected from the group consisting of bisphenol A epoxy resin, bisphenol F epoxy resin, bisphenol S epoxy resin, bisphenol M epoxy resin, and bisphenol AD epoxy resin, trimethylolpropane triglycidyl ether epoxy resin, triglycidyl isocyanurate, trimethylolmethane triglycidyl ether, tetraglycidyl methylenedianiline epoxy resin, tetraglycidyl diaminodiphenylmethane epoxy resin, novolac-based tetraglycidyl epoxy resin, tetraglycidyl cresol novolac epoxy resin, and phenol novolac epoxy resin.

3. (canceled)

4. The modified epoxy resin composition of claim 1,
wherein the composition further comprises a curing agent.

5. The modified epoxy resin composition of claim 4,
wherein 20 to 50 parts by weight of the curing agent are included based on 100 parts by weight of the epoxy resin (A).

6. The modified epoxy resin composition of claim 4,
wherein the curing agent is any one or a combination of two or more selected from the group consisting of diethylenetriamine, triethylene diamine, triethylenetetramine, tetraethylene-pentamine, 2,2,4- and/or 2,4,4-trimethylhexamethylenediamine, 1,6-hexanediamine, 1-ethyl-1,3-propanediamine, 2,2 (4), 4-trimethyl-1,6-hexanediamine, bis(3-aminopropyl) piperazine, N-aminoethylpiperazine, N,N-bis(3-aminopropyl)ethylenediamine, 1,2-diaminocyclohexane, 1,4-diamino-2,5-diethylcyclohexane, 1,2-diamino-4-ethylcyclohexane, 1,4-diamino-2,5-diethylcyclo-hexane, 1,2-diamino-4-cyclohexylcyclohexane, isophorone diamine, norbornanediamine, 4,4′-diaminodicyclohexylmethane, 4,4′-diaminodicyclohexylethane, 4,4′-diaminodicyclohexylpropane, 2,2-bis(4-aminocyclohexyl) propane, 3,3′-dimethyl-4,4′-diaminodicyclohexylmethane, 3-amino-1-(4-aminocyclohexyl) propane, 1,3- and 1,4-bis(aminomethyl)cyclohexane, 3,3′-diaminodiphenylsulfone, 4,4′-diaminodiphenylsulfone, meta-methylisopropylamine, and meta-diethylamine.

7. A method for producing a modified epoxy resin using the composition of claim 1.

8. A modified epoxy resin comprising the composition of claim 1.
